(19) United States
(12) Patent Application Publication
(10) Pub. No.: US 2007/0194121 A1
(43) Pub. Date: Aug. 23, 2007

(54) Structures and methods thereof for scanner with two CCD arrays

(75) Inventors: Jin-Chun Yang, Hsinchu (TW); Harn-Jou Yeh, Hsinchu (TW)

Correspondence Address: BIRCH STEWART KOLASCH & BIRCH, PO BOX 747, FALLS CHURCH, VA, 22040-0747, US

(73) Assignee: Microtek International Inc.

(21) Appl. No.: 11/525,137

(22) Filed: Sep. 22, 2006

(30) Foreign Application Priority Data
Feb. 23, 2006 (TW) 95106076
Apr. 18, 2006 (TW) 95113788

(51) Int. Cl. G06K 7/10

(52) U.S. Cl. 235/454

(57) ABSTRACT

Structures and methods thereof for a scanner with two CCD arrays, which respectively capture two independent object images in one scan action, are provided. Three functions: a. image recovery, b. double resolution, and c. high dynamic range can be achieved for the transparent media and the reflective media. The image defects caused by the dust, pollutants, or scratches can be recovered by comparing the different shadows formed by two light-sources in two object images for the reflective media or comparing two object images formed respectively by a visible light-source and a infrared light-source for the transparent and reflective media. The function of double resolution can be achieved by making a relative displacement of half pixel-distance between two CCD arrays in their longitudinal direction. The function of high dynamic range can be achieved by setting two different exposure time for two CCD arrays.

### BACKGROUND OF THE INVENTION

1. Field of the Invention

The present invention relates to the structures and methods of a scanner, and more particularly, to the structures and methods with two CCD arrays which capture two independent object images in one scan action.

2. Description of the Prior Art

The image scanner is an apparatus to capture the object images and convert them into digital data which can be displayed, edited, stored, processed, and output by the computer.

The scanned objects can be distinguished as the transparent media and reflective media. The transparent media are partial-transparent materials including the films, the slides, and the transparencies, etc. And the reflective media are opaque materials including the photographs, the paper documents, and the printed materials, etc. The Taiwan patent, patent No. 161970, discloses a scanner structure which can scan both the transparent media and the reflective media. Presently, the dual-mode scanner, which can scan both transparent media and reflective media, has been very widely used.

Because of its small volume and low cost, the flatbed scanner is the most popular kind of the scanner nowadays. The basic working principle of the flatbed scanner is described as following. It has an optical carriage which movement is controlled by a program, and the scanned object remains static during the scan action. Generally, the optical carriage is connected to a programmable stepping motor and driven to move smoothly on a guiding track, and it usually includes a photo-sensing array; a mirror set to change the direction of the image beam; and a lens to focus and image the image beam.

The light emitted from a light-source irradiates to a scanned object, and then the reflected or transmitted image beam impinge onto the linear photo-sensing array to be exposed and captured as the analog electronic signals, and then converted into the digital electronic data to store in the memory unit of the scanner for further process or output. Because the direction of the linear photo-sensing array is perpendicular to the scan direction of the optical carriage, the digital data of the 2-dimensional object image can be obtained by appropriately controlling the movement of the optical carriage and the exposure of the linear photo-sensing array.

Because of the reasonable price and good quality, the Charge Coupled Device (CCD) array is the most common kind of the linear photo-sensing array. It is consisting of a plurality of CCDs to form a line shape. Every CCD represents an image pixel, which resolution is expressed by dot per inch (dpi). For example, a resolution of 1200 dpi represents the CCD array has 1200 pixels corresponding to one-inch width of scanned document. The black-and-white scanner adopts a single-line grayscale CCD array, and the color scanner adopts the three-line Red-Green-Blue (RGB) CCD array as shown in FIG. 1. The RGB CCD arrays 2 has a red CCD array 3, a green CCD array 4, and a blue CCD array 5, which are used to capture the red, green, and blue image beams to synthesize a color image of the scanned object.

Quick scan and high resolution are two important objectives for the scanner to pursue. If remaining the length of CCD array unchanged, then increasing the number of pixels will reduce the sensing area of each CCD and so as to lower down the sensitivity and the signal to noise ratio. Therefore, the scanner needs to increase the exposure time to compensate, it will slow down the scan speed and this is an unwanted drawback.

Accordingly, there are some other approaches to raise the resolution. Some Japan companies such as NEC, Toshiba, and Sony have the stagger type CCD arrays, which are implemented by relatively displacing half pixel-distance between two adjacent CCD arrays. As shown in FIG. 2, the stagger type of RGB CCD arrays 10 contain 6 CCD arrays, arranging as red 11, red 12, green 13, green 14, blue 15, blue 16. The distance between two adjacent pixels in every CCD array is “P”, and every two CCD arrays with the same color have a relative longitudinal displacement of half pixel-distance “P/2”. Therefore, the scanner resolution is raised to two folds compared to a single CCD array. For example, the scanner resolution will be 2400 dpi if the resolution of the CCD array is 1200 dpi.

In addition, the United State patent of U.S. Pat. No. 6,707,583 discloses another scanner structure and the method thereof to raise the resolution. The CCD array has a movement freedom in the direction perpendicular to the movement of the optical carriage, and the scanner scans twice for the scanned object. The CCD array moves a half pixel-distance in the direction perpendicular to the movement of the optical carriage before the second scan action. Corresponding to the same scan-line of the scanned object. Therefore, after processing and synthesizing the two object images contained in the first and second scan action, the resolution of output image is raised to two folds comparing to the image obtained in one scan action.

However, the drawback of this kind of method to raise the scanner resolution is that it needs to scan twice, and so as to double the overall scan time.

In addition to the speed and resolution, the quality of the scanned image is more and more demanded by people, too. Along with the progress of the technology, there are several techniques to recover the defects of the scanned image caused by the hetero-points such as the dust, pollutants, or scratches on the scanned object. For example, the ICE (Image Correction Enhancement) function of the KADC (Kodak Austin Development Center) and the United State patent of U.S. Pat. No. 6,707,583, they utilize the fact that the film dyes are transparent, but the hetero-points are relatively opaque to the Infrared (IR) light to recover the defects of the scanned image for the transparent media. They use a visible light-source and an IR light-source to respectively scan the transparent media twice and then compare and process the two scanned images to store or output a recovered image.

On the other hand, the Taiwan patent of patent No. 120212 utilizes the fact, that the hetero-points will form two different shadows on the scanned images if irradiating two incident lights with two different angles onto a reflective media in two scan actions. Therefore, the defects of the scanned image caused by the hetero-points for the reflective media can be recovered by comparing and processing the two scanned images, and then a recovered image can be stored or output.

However, the drawback of this kind of method to recovery the defects of the scanned image for the reflective media is that it needs to scan twice, and so as to double the overall scan time.

Additionally, the high dynamic range, which means that the scanned image has clear details in the shadows, is also an objective for the scanner to pursue,. The high dynamic range can be achieved by lengthening the exposure time of every scan-line, but the long exposure time will possibly saturate some CCDs corresponding to the highlights in the scanned image and so as to lose some image details of the highlights. One better way is to scan the object twice using two different exposure time, and then synthesize the two scanned images, which the highlights of the composite image adopt the image with short exposure time and the shadows of the composite image adopt the image with long exposure time.

However, the drawback of this kind of method to achieve the objective of high dynamic range is that it needs to scan twice, and so as to double the overall scan time.

### SUMMARY OF THE INVENTION

In order to solve the aforementioned problems which scan slowly or need to scan twice to raise the scanner resolution in the prior art, one purpose of the present invention is to provide structures and methods thereof for a scanner with two CCD arrays, which capture two independent object images in one scan action. And the double resolution can be achieved by making a relative displacement of half pixel-distance between two CCD arrays in their longitudinal direction.

In order to solve the aforementioned problem that needs to scan twice to recover the image defects caused by the hetero-points such as the dust, pollutants, or scratches on the scanned object, one purpose of the present invention is to provide structures and methods thereof for a scanner with two CCD arrays, which capture two independent object images in one scan action. And the image defects caused by the hetero-points can be recovered by comparing the different shadows formed by irradiating two incident lights with different angles for the reflective media, or comparing two object images separately formed by a visible light-source and an IR light-source for the transparent media or the reflective media.

In order to solve the aforementioned problem that needs to scan twice to achieve the objective of high dynamic range, one purpose of the present invention is to provide structures and methods thereof for a scanner with two CCD arrays, which capture two independent object images in one scan action. And the high dynamic range can be achieved by setting two different exposure time for two CCD arrays.

One purpose of the present invention is to provide structures and methods thereof for a scanner with two CCD arrays to scan the transparent media and the reflective media, which can be implemented in separate or integrated structure with one or two focus-image lenses to provide three operation modes and functions: a. image recovery; b. double resolution; and c. high dynamic range.

Consequently, the structures and methods thereof of the present invention for a scanner with two CCD arrays can effectively lower down the scan time and elevate the quality of the scanned image.

To achieve the purposes mentioned above, one embodiment of the present invention is to provide structures and methods thereof to scan the reflective media. The optical carriage has two light-sources, their emitted lights impinge on the surface of a reflective medium in different incident angles and two reflected image beams are formed. Then, two focus-image lenses respectively focus and image the reflected image beams on two CCD arrays to capture two independent images of the reflective medium in one scan action.

To achieve the purposes mentioned above, one embodiment of the present invention is to provide structures and methods thereof to scan the transparent media. The emitted light from a light-source forms a transmitted image beam behind a transparent medium, and a beam splitter contained in the optical carriage splits the transmitted image beam into two transmitted image partial-beams. Then, two focus-image lenses respectively focus and image the transmitted image partial-beams on two CCD arrays to capture two independent images of the transparent medium in one scan action.

To achieve the purposes mentioned above, one embodiment of the present invention is to provide a structure and a method thereof to switch two operation modes of the reflective media and the transparent media by utilizing two switching mirrors contained in the optical carriage.

To achieve the purposes mentioned above, one embodiment of the present invention is to provide structures and methods thereof to scan the reflective media. The emitted light from a light-source forms a reflective image beam on the surface of a reflective medium, and the reflective image beam is split into two reflective image partial-beams by a beam splitter behind a focus-image lens. Then, the two reflective image partial-beams are respectively focused and imaged on two CCD arrays, and thus two independent images of the reflective medium are captured in one scan action.

To achieve the purposes mentioned above, one embodiment of the present invention is to provide structures and methods thereof to scan the transparent media. The emitted light from a light-source forms a transmitted image beam behind a transparent medium, and the transmitted image beam is split into two transmitted image partial-beams by a beam splitter behind a focus-image lens. Then, the two transmitted image partial-beams are respectively focused and imaged on two CCD arrays, and thus two independent images of the transparent medium are captured in one scan action.

To achieve the purposes mentioned above, one embodiment of the present invention is to provide a structure and a method thereof to switch two operation modes of the reflective media and the transparent media by utilizing a switching mirror contained in the optical carriage.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram of a three-lines RGB CCD arrays;

FIG. 2 is a schematic diagram of a stagger type RGB CCD arrays;

FIG. 3 is a schematic diagram of the scanner structure with two CCD arrays and two focus-image lenses which can scan the transparent media and the reflective media according to the first embodiment of the present invention;

FIG. 4A, FIG. 4B, and FIG. 4C are the schematic diagrams of the scan process for the transparent media according to the structure illustrated in FIG. 3;

FIG. 5A, FIG. 5B, and FIG. 5C are the schematic diagrams of the scan process for the reflective media according to the structure illustrated in FIG. 3;

FIG. 6A and FIG. 6A are the schematic diagrams of the scan process for a dust particle on the surface of a reflective medium according to the second embodiment of the present invention;

FIG. 7A and FIG. 7A are the schematic diagrams to illustrate the relative displacement of half pixel-distance between two CCD arrays according to the fourth embodiment of the present invention;

FIG. 8 is a schematic diagram to illustrate how the scanner memory stores the pixels' data in a stagger type for the CCD arrays illustrated in FIG. 7A and FIG. 7B; and

FIG. 9 is a schematic diagram of the scanner structure with two CCD arrays and one focus-image lens which can scan the transparent media and the reflective media according to the eighth embodiment of the present invention.

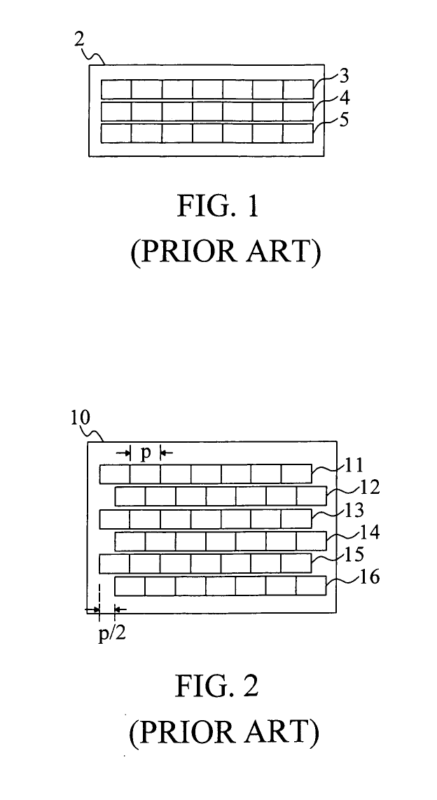

### DESCRIPTION OF THE PREFERRED EMBODIMENT

The scanner with two CCD arrays according to the present invention can be implemented in separate structures to respectively scan the transparent media and the reflective media, or incorporated with some switching mirrors to form an integrated structure that is able to scan both the transparent media and the reflective media. And the integrated structure with two CCD arrays according to the present invention may be further divided into two kinds of structures which have one or two focus-image lenses.

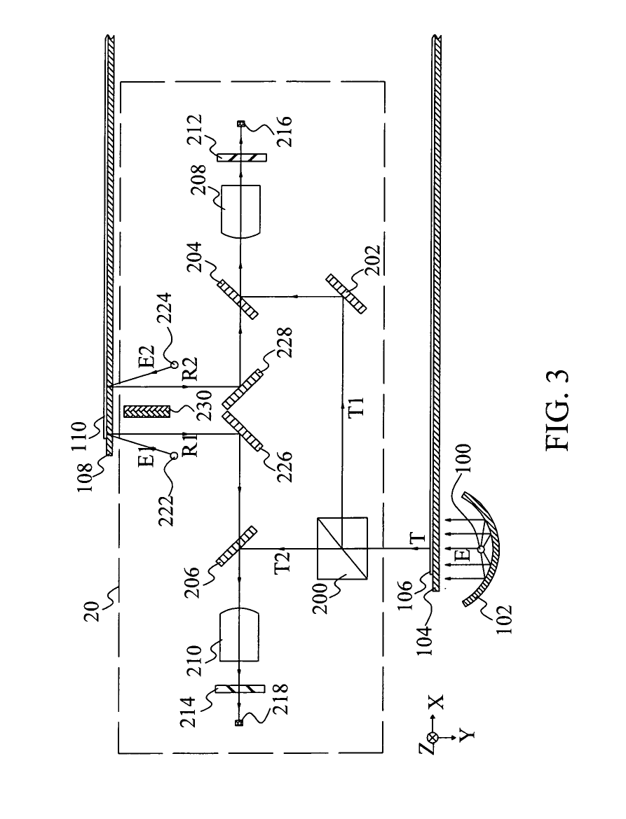

FIG. 3 is a schematic diagram of the scanner structure with two CCD arrays and two focus-image lenses which can scan the transparent media and the reflective media according to the first embodiment of the present invention.

Firstly, the scan process for the transparent media is explained as followed. A transparent medium 106 is set on a transparent plate 104. In one preferred embodiment, transparent plate 104 can be a film holder to hold a scanned film at a scan position. A light-source 100, located below the glass plate 104, is composed of a Cold Cathode Fluorescent Lamp (CCFL) or its similar visible light-source and an Infrared Light Emitting Diode (IR-LED). The CCFL or its similar visible light-source and the IR-LED can be controlled to illuminate separately or simultaneously. The curved mirror 102 is used to reflect the back-light of the light-source 100 to enhance the intensity of the incident light “E” for the transparent medium 106, it can be omitted if the intensity of the light-source 100 is already strong enough.

The incident light “E” impinge on the transparent medium 106 through the glass plate 104, then the transmitted image beam “T” enters into the optical carriage 20 that may be connected to a programmable driving motor (not shown in the figure). The optical carriage 20 can be driven to move smoothly on a guiding track (not shown in the figure) along the “X”-direction, and it contains a beam splitter 200 which splits the transmitted image beam “T” into two transmitted image partial-beams “T1” and “T2”. The transmitted image partial-beams “T1” and “T2” and the CCD arrays 216 and 218 respectively form two independent optical routes. In one preferred embodiment, the beam splitter 200 reflects approximate 50% of the transmitted image beam “T” by an angle to form the transmitted image partial-beam “T1”, and transmits approximate 50% of the transmitted image beam “T” to form the transmitted image partial-beam “T2”.

A fixed mirror 202, two switching mirrors 204 and 206, two focus-image lenses 208 and 210, and two switching filters 212 and 214 are set in the optical routes. The fixed mirror 202 is used to change the direction of the transmitted image partial-beam “T1”. The switching mirrors 204 and 206, which can be switched to depart from the optical routes when scanning the reflective media, are used to change the directions of the transmitted image partial-beams “T1” and “T2” to make them respectively impinge on the focus-image lenses 208 and 210. The focus-image lenses 208 and 210 are used to focus and image the transmitted image partial-beams “T1” and “T2” on the CCD arrays 216 and 218. The switching filters 212 and 214 can be switched to set in or depart from the optical routes depending on the different operation modes.

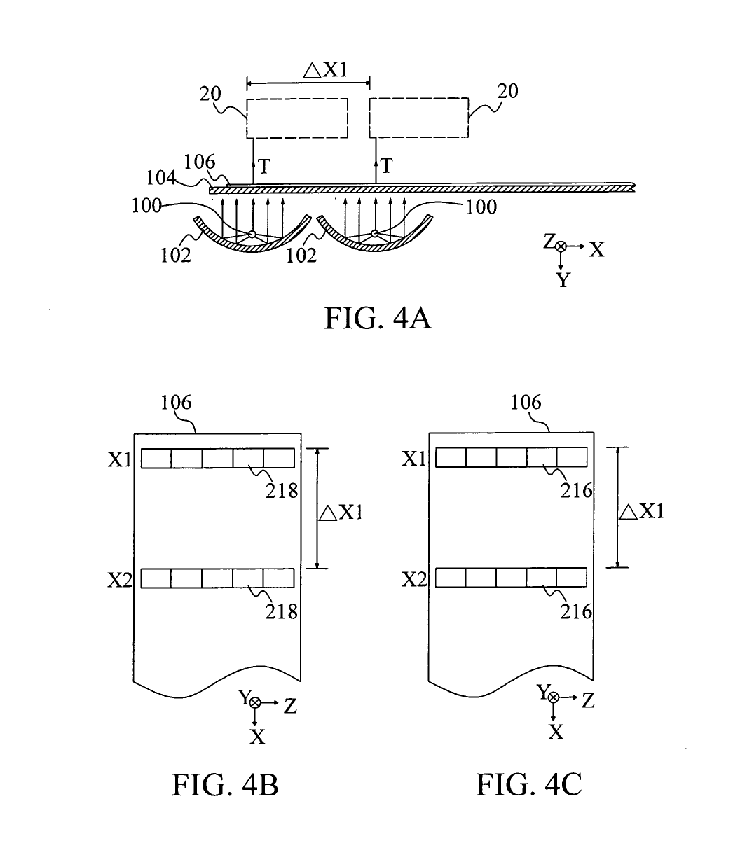

FIG. 4A, FIG. 4B, and FIG. 4C illustrate the scan process of the transparent medium 106. The transparent medium 106 remains static, but the illuminating light-source 100, the curved mirror 102, and the optical carriage 20 move together along the “X”-direction. CCD arrays 216 and 218 will capture the image of one scan-line in the transparent medium 106 after every exposure. Refer to the figures, the optical carriage 20 keep moving a distance “.X1” after CCD arrays 216 and 218 have exposed to capture the image of the scan-line at the position “X1” in the transparent medium 106. Then, CCD arrays 216 and 218 expose again to capture the image of the scan-line at the position “X2” in the transparent medium 106.

Hence, the scan-lines of the CCD arrays 216 and 218 may distribute orderly on the entire surface of the transparent medium 106, and two complete images of the transparent medium 106 are obtained after the scan action. The captured images can be converted into digital electronic data to store in the memory of the scanner for the proceeding process or output.

For the explaining convenience, there are just 5 pixels depicted for the CCD arrays 216 and 218 in FIG. 4A, FIG. 4B, and FIG. 4C. Practically, they may be the single-line grayscale CCD array or the three-line RGB CCD array with a plurality of pixels. And their resolution may be 600 dpi or 1200 dpi, etc.

Next, the scan process for a reflective media is explained as followed. Please refer to FIG. 3 again. A reflective medium 110 is set on a transparent plate 108. There are two light-sources 222 and 224 in the optical carriage 20, they are CCFLs or their similar visible light-sources in one preferred embodiment. Their incident lights “E1” and “E2” transmit through the transparent plate 108, and then are reflected on the surface of the reflective medium 110. The reflected image beams “R1” and “R2” come back to the optical carriage 20 and form two independent optical routes with the CCD arrays 218 and 216 respectively. A spacing apparatus 230 is set between the light-sources 222 and 224 to separate the optical routes, so the reflected image beam “R1” is captured only by the CCD array 218 and the reflected image beam “R2” is captured only by the CCD array 216. Two fixed mirrors 228 and 226, and two focus-image lenses 208 and 210 are set in the optical routes.

The fixed mirrors 228 and 226 are used to change the directions of the reflected image beams “R1” and “R2”, and the focus-image lenses 208 and 210 are used to focus and image the reflected image beams “R1” and “R2” on the CCD arrays 216 and 218. The switching mirrors 204 and 206, and the switching filters 212 and 214 are switched to depart from the optical routes in the scan operation for the reflective media.

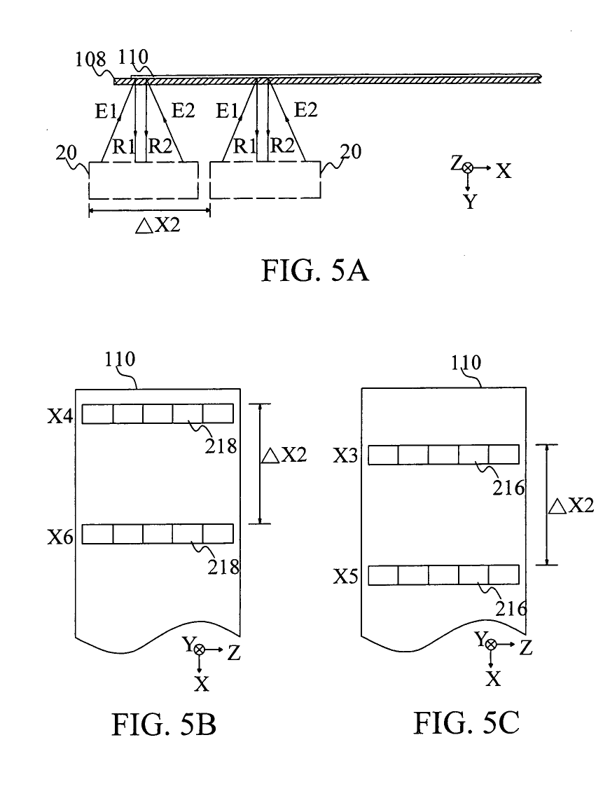

FIG. 5A, FIG. 5B, and FIG. 5C illustrate the scan process of the reflective medium 110. The reflective medium 110 remains static. Two light-sources 222 and 224 illuminate, and the optical carriage 20 moves along the “X”-direction. The optical carriage 20 keep moving a distance “.X2” after CCD arrays 216 and 218 have exposed to capture the images of the scan-lines at the positions “X3” and “X4” of the reflective medium 110. Then, CCD arrays 216 and 218 expose again to capture the images of the scan-lines at the position “X5” and “X6” of the reflective medium 110.

Hence, similar to the scan process for the transparent medium 106, the scan-lines of the CCD arrays 216 and 218 may distribute sequentially on the entire surface of the reflective medium 110, and two complete images of the reflective medium 110 are obtained after the scan action. The captured images can be converted into the digital electronic data to store in the memory of the scanner for the proceeding process or output.

It can be appreciated by one skilled in the art that the quantity and position of the fixed mirrors 202, 226, 228 and the switching mirrors 204, 206 in FIG. 3 can be changed to alter the directions of the optical routes for the transmitted and reflective image beams, and so as to meet the practical requirements in one preferred embodiment.

The main feature of the present invention can be understood from the above description that two CCD arrays respectively capture two independent object images in one scan action, and the present invention can be applied for the transparent and reflective media. Therefore, three operation modes and particular functions of the present invention: a. image recovery; b. double resolution; and c. high dynamic range can be implemented by incorporating some detailed design and system setting into the basic structure of FIG. 3. The structures and methods to realize the three particular functions for the transparent and reflective media are described in the following different embodiments.

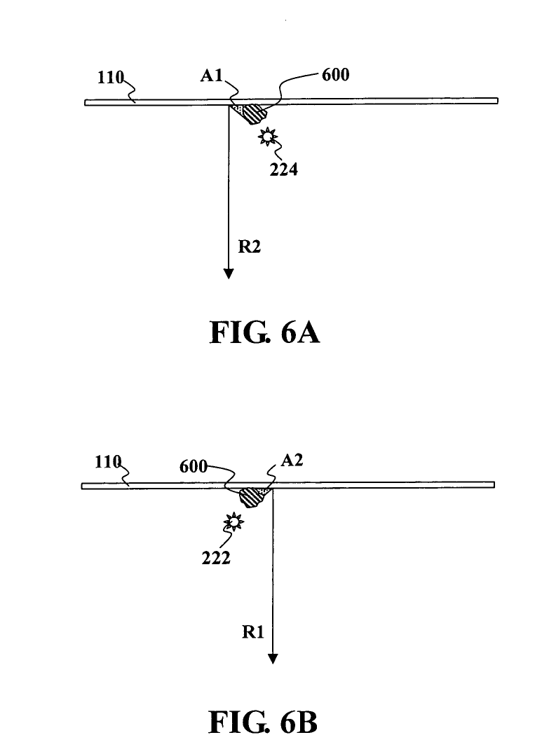

Firstly, the second embodiment is to explain the function of the image recovery of the present invention for the reflective medium 110. Please refer to FIG. 3 again. It can be understood from the previous description that the CCD arrays 216 and 218 respectively receive the reflective image beams which are originated from the two light-sources 222 and 224 and reflected on the surface of the reflective medium 110. After the scan action, the CCD arrays 216 and 218 respectively receive two independent images of the reflective medium 110. The incident lights “E1” and “E2” emitted from the light-sources 222 and 224 are located at two different sides of a normal, which is normal to the plane of the reflective medium 110 and between the two light-sources 222 and 224. It means that the two incident lights “E1” and “E2” have different incident angles. Therefore, the hetero-points such as the dust, pollutants, or scratches on the scanned object will form two different shadows on the scanned images of the CCD arrays 216 and 218. Please refer to FIG. 6A and FIG. 6B, a dust particle on the surface of the reflective medium 110 forms a shadow “A1” on the scanned image of the CCD array 216 and a shadow “A2” on the scanned image of the CCD array 218. The range of “A2” is not equal to the range of “A1”, thus the defects of the scanned image caused by the hetero-points for the reflective media 110 can be recovered by comparing and processing the two scanned images of the CCD arrays 216 and 218, and then a recovered image can be stored or output.

The third embodiment is to explain the function of the image recovery of the present invention for the transparent medium 106, please refer to FIG. 3 again. The CCFL or its similar visible light-source and the IR-LED of the light-source 100 illuminate simultaneously and move along with the optical carriage 20 in the “X”-direction. The two switching filters 212 and 214, which are the visible-light filter and the IR-light filter respectively, are set in the optical routes. Therefore, the CCD arrays 216 and 218 respectively receive a visible-light image and an IR-light image of the transparent medium 106. Because the dyes are transparent and the hetero-points are relatively opaque to the IR light, thus the defects of the scanned image caused by the hetero-points for the transparent medium 106 can be recovered by comparing and processing the two scanned images of the CCD arrays 216 and 218, and then a recovered image can be stored or output.

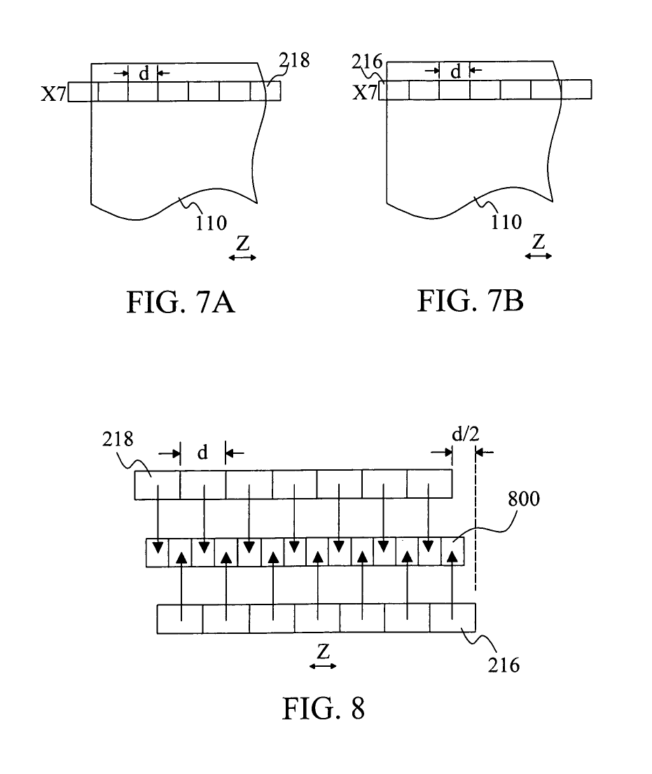

The fourth embodiment is to explain the function of the double resolution of the present invention for the reflective medium 110, please refer to FIG. 7A and FIG. 7B. The CCD arrays 216 and 218 have sequentially captured the scan-line image at the position “X7” in the reflective medium 110. For the explaining convenience, there are just 7 pixels depicted for the CCD arrays 216 and 218. The CCD arrays 216 and 218 have the same pixel quantity and pixel-distance “d”, and have a relative displacement of half pixel-distance “d/2” in their longitudinal direction (“Z-direction”). In one preferred embodiment, the half pixel-distance “d/2” can be fulfilled by setting a motor or a linear driving module to move on a guiding track along the “Z”-direction.

Please refer to FIG. 8, the scanner memory 800 has two folds of memory-units for the scan-line image comparing to the pixel quantity of the CCD arrays 216 and 218, the quantity of the memory-units in FIG. 8 is 14. The scanner store the scan-line images of the CCD arrays 216 and 218 into the scanner memory 800 in a stagger type, it means that the odd memory-units store the scan-line image of the CCD array 218 and the even memory-units store the scan-line image of the CCD array 216 as shown in FIG. 8. Thus, the scanner memory 800 stores two folds of pixel images for the scan-line comparing to the respective CCD array. Consequently, the scanner resolution is raised to two folds comparing to a single CCD array. For example, the scanner resolution will be 1200 dpi if the resolution of the CCD array is 600 dpi.

The fifth embodiment is to explain the function of the double resolution of the present invention for the transparent medium 106, please refer to FIG. 3 again. The CCFL or its similar visible light-source of the light-source 100 illuminates, and the two switching filters 212 and 214 are switched to depart from the optical routes. The setup of the CCD arrays 216, 218 and the way that the scanner stores their images are the same as the fourth embodiment, it's not to further describe hereafter.

The sixth embodiment is to explain the function of the high dynamic range of the present invention for the reflective medium 110, please refer to FIG. 3 again. The control-signals of the system are set to make the CCD arrays 216 and 218 have different exposure time for every scan-line of the reflective medium 110.

After processing and synthesizing the two scanned images respectively captured by the CCD arrays 216 and 218 using different exposure time, a composite image can be stored or output. The highlights of the composite image adopt the scanned image with a short exposure time, and the shadows of the composite image adopt the scanned image with a long exposure time. For example, the exposure time of CCD array 216 is set as 4 times as the exposure time of CCD array 218, then the highlights of the composite image will adopt the scanned image of CCD array 218 and the shadows of the composite image will adopt the scanned image of CCD array 216. Consequently, the composite image to be stored or output is a clear image with a high dynamic range.

The seventh embodiment is to explain the function of the high dynamic range of the present invention for the transparent medium 106, please refer to FIG. 3 again. The CCFL or its similar visible light-source of the light-source 100 illuminates, and the two switching filters 212 and 214 are switched to depart from the optical routes. The different exposure time for the CCD arrays 216 and 218 and the way that the scanner synthesizes their images are the same as the sixth embodiment, it's not to further describe hereafter.

To sum up the above description from the second embodiment to the seventh embodiment, six operation modes which the user can select: M1. reflective medium—image recovery; M2. transparent medium—image recovery; M3. reflective medium—double resolution; M4. transparent medium—double resolution; M5. reflective medium—high dynamic range; and M6. transparent medium—high dynamic range can be implemented by incorporating some detailed design and system setting into the scanner structure with two CCD arrays and two focus-image lenses of the present invention in FIG. 3.

It can be appreciated by one skilled in the art that the scanner with two CCD arrays and two focus-image lenses and the method thereof of the present invention can also be implemented in separate structures to scan the transparent media and the reflective media respectively.

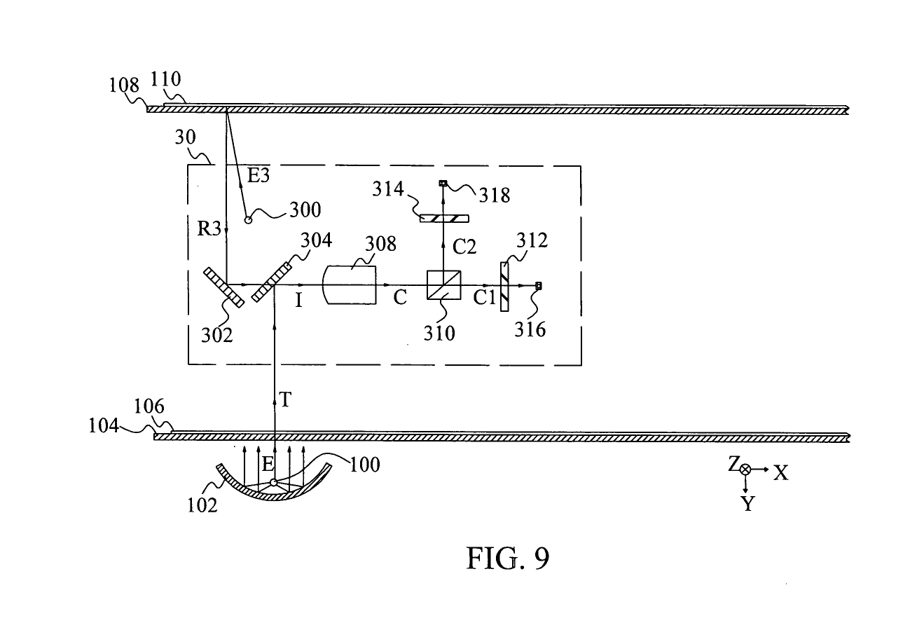

FIG. 9 is a schematic diagram of the scanner structure with two CCD arrays and one focus-image lens which can scan the transparent media and the reflective media according to the eighth embodiment of the present invention. The optical carriage 30 includes: a light-source 300; a fixed mirror 302; a switching mirror 304 to switch the transparent media mode and the reflective media mode; a focus-image lens 308; a beam splitter 310; two switching filters 312 and 314; and two CCD arrays 316 and 318.

Firstly, the optical routes of the scanner structure in FIG. 9 for the transparent medium 106 are explained as followed. The transmitted image beam “T” enters into the optical carriage 30, and the switching mirror 304 is set in the optical route to reflect the transmitted image beam “T” as the incident image beam “I” of the focus-image lens 308. The output image beam “C” of the focus-image lens 308 impinge on the beam splitter 310 and is split by it into two image partial-beams “C1” and “C2”. Then, the two image partial-beams “C1” and “C2” are respectively focused and imaged on the CCD arrays 316 and 318.

Comparing the scanner structure with two CCD arrays and one focus-image lens in FIG. 9 to the scanner structure with two CCD arrays and two focus-image lenses in FIG. 3, both of them have the same transparent medium 106, transparent plate 104, light-source 100, and curved mirror 102. The CCD arrays 316 and 318 are equivalent to CCD arrays 216 and 218; the switching filters 312 and 314 are equivalent to switching filters 212 and 214; the beam splitter 310 is equivalent to the beam splitter 200; and the optical carriage 30 is equivalent to the optical carriage 20. The difference is that the beam splitter 310 in FIG. 9 is set behind the focus-image lens 308, thus the image partial-beams “C1” and “C2” are equivalent to the transmitted image partial-beams “T1” and “T2”.

It can be appreciated by one skilled in the art that the scan process of the eighth embodiment in FIG. 9 for the transparent media 106 is similar to the first embodiment in FIG. 3, so it's not to further describe hereafter.

Hence, One feature of the eighth embodiment is that two CCD arrays 316 and 318 respectively capture two independent images of the transparent medium 106 in one scan action. One skilled in the art can appreciate that the three operation modes which the user can select: M2. transparent medium—image recovery; M4. transparent medium—double resolution; and M6. transparent medium—high dynamic range can be implemented by incorporating similar detailed design and system setting with the third embodiment, fifth embodiment and seventh embodiment of the present invention previously described, it's not to further describe hereafter.

Next, the optical routes of the scanner structure in FIG. 9 for the reflective medium 110 are explained as followed. Similar to the light-source 100 for scanning transparent medium 106, the light-source 300 for scanning reflective medium 110 is composed of a CCFL or its similar visible light-source and an IR-LED. The incident light “E3” transmits through the transparent plate 108, and then is reflected on the surface of the reflective medium 110. The reflected image beam “R3” come back to the optical carriage 30, and then reflected by the fixed mirror 302 as the incident image beam “I” of the focus-image lens 308. The switching mirror 304 is switched to depart from the optical route in the operation modes for the reflective medium 110. The output image beam “C” of the focus-image lens 308 impinge on the beam splitter 310 and is split by it into two image partial-beams “C1” and “C2”. Then, the two image partial-beams “C1” and “C2” are respectively focused and imaged on the CCD arrays 316 and 318.

Hence, the optical routes of the scanner structure in FIG. 9 for scanning the reflective medium 110 and the transparent medium 106 are very similar. The difference is the formation source of the input image beam “I” of the focus-image lens 308: it is formed using the fixed mirror 302 to reflect the reflected image beam “R3” in scanning the reflective medium 110; and it is formed using the switching mirror 304 to reflect the transmitted image beam “T” in scanning the transparent medium 106. In other words, the light-source 300 and the fixed mirror 302 are equivalent to the light-source 100 and the switching mirror 304. Accordingly, one skilled in the art can appreciate that the scan processes for the reflective medium 110 and the transparent medium 106 in FIG. 9 are very similar, so it's not to further describe hereafter.

It can be appreciated by one skilled in the art that the quantity and position of the fixed mirror 302 and the switching mirror 304 in FIG. 9 can be changed to alter the directions of the optical routes for the transmitted and reflective image beams, and so as to meet the practical requirements in one preferred embodiment.

Therefore, One feature of the eighth embodiment is that two CCD arrays 316 and 318 respectively capture two independent images of the reflective medium 110 in one scan action. One skilled in the art can appreciate that the three operation modes which the user can select: M1. reflective medium—image recovery; M3. reflective medium—double resolution; and M5. reflective medium—high dynamic range can be implemented by incorporating some detailed design and system setting.

Firstly, the operation mode: M1. reflective medium—image recovery of the eighth embodiment in FIG. 9 is explained as followed. The CCFL or its similar visible light-source and the IR-LED of the light-source 300 illuminate simultaneously. The two switching filters 312 and 314, which are the visible-light filter and the IR-light filter respectively, are set in the optical routes.

Therefore, the CCD arrays 316 and 318 respectively receive a visible-light image and an IR-light image of the reflective medium 110. Therefore, the defects of the scanned image caused by the hetero-points for the reflective medium 110 can be recovered by comparing and processing the visible-light image and the IR-light image, and then a recovered image can be stored or output.

Next, the operation mode: M3. reflective medium—double resolution of the eighth embodiment in FIG. 9 is explained as followed. The CCFL or its similar visible light-source of the light-source 300 illuminates, and the two switching filters 312 and 314 are switched to depart from the optical routes. The configuration for the CCD arrays 316 and 318 is similar to which for the CCD arrays 216 and 218 of the fourth embodiment. Hence, the CCD arrays 316 and 318 have the same pixel quantity and pixel-distance, and have a relative displacement of half pixel-distance in their longitudinal direction. The way that the scanner stores the scanned images of the CCD arrays 316 and 318 in a stagger type is the same as the fourth embodiment, it's not to further describe hereafter.

Lastly, the operation mode: M5. reflective medium—high dynamic range of the eighth embodiment in FIG. 9 is explained as followed. The CCFL or its similar visible light-source of the light-source 300 illuminates, and the two switching filters 312 and 314 are switched to depart from the optical routes. The control-signals of the system are set to make the CCD arrays 316 and 318 have different exposure time for every scan-line of the reflective medium 110. After processing and synthesizing the two scanned images respectively captured by the CCD arrays 316 and 318 using different exposure time, a composite image can be stored or output. The highlights of the composite image adopt the scanned image with short exposure time, and the shadows of the composite image adopt the scanned image with long exposure time.

One skilled in the art can appreciate that the scanner with two CCD arrays and one focus-image lens and the method thereof of the present invention can also be implemented in separate structures to scan the transparent media and the reflective media respectively.

To sum up, the main feature of the present invention can be understood from the above description that two CCD arrays respectively capture two independent object images in one scan action, and the present invention can be applied for the transparent and reflective media. The present invention may be implemented in two kinds of structures which have one or two focus-image lenses, and three particular functions of the present invention: a. image recovery; b. double resolution; and c. high dynamic range can be realized in various operation modes by incorporating some detailed design and system setting. Meanwhile, the present invention can be implemented in an integrated structure that is able to scan both the transparent media and the reflective media, or in separate structures to respectively scan the transparent media and the reflective media.

Consequently, the structures and methods thereof of the present invention for a scanner with two CCD arrays can effectively lower down the scan time and elevate the quality of the scanned image.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. A scanner, comprising:
a transparent plate to hold a reflective medium;
a first light-source movably set below said transparent plate, wherein a first incident light emitted from said first light-source reflects on a surface of said reflective medium to form a first reflected image beam;
a second light-source movably set below said transparent plate and separate from said first light-source by a distance, wherein a second incident light emitted from said second light-source reflects on said surface of said reflective medium to form a second reflected image beam, and said second reflected image beam and said first reflected image beam are formed in one scan action;
a first Charge Coupled Device . CCD . array set below said transparent plate to receive said first reflected image beam;
a second CCD array set below said transparent plate to receive said second reflected image beam; and
spacing apparatus set between said first light-source and said second light-source to prevent said first reflected image beam from irradiating on said second CCD array and prevent said second reflected image beam from irradiating on said first CCD array.

2. The scanner according to claim 1, further comprising moving apparatus set below said transparent plate to move said first light-source, said second light-source, said first CCD array, said second CCD array and said spacing apparatus.

3. The scanner according to claim 1, further comprising a beam-directing module set below said transparent plate to direct said first reflected image beam into said first CCD array and direct said second reflected image beam into said second CCD array.

4. The scanner according to claim 3, wherein said beam-directing module comprises at least one mirror to alter an optical route of said first reflected image beam or said second reflected image beam.

5. The scanner according to claim 1, further comprising a focus-image lens-module set below said transparent plate to respectively focus and image said first reflected image beam and said second reflected image beam on said first CCD array and said second CCD array.

6. The scanner according to claim 1, wherein said first light-source and said second light-source are Cold Cathode Fluorescent Lamps (CCFLs) or their similar visible light-sources.

7. The scanner according to claim 1, wherein said first CCD array and said second CCD array are selected from the group consisting of a single-line grayscale CCD array and a three-line Red-Green-Blue (RGB) CCD array.

8. The scanner according to claim 1, wherein said first CCD array and said second CCD array have the same pixel quantity and pixel-distance and have a relative displacement of half pixel-distance in their longitudinal direction.

9. The scanner according to claim 8, comprising a motor or a linear driving module to drive said second CCD array to move said half pixel-distance.

10. A scanner, comprising:
a transparent plate to hold a transparent medium;
a light-source movably set below said transparent plate, wherein an incident light emitted from said light-source impinges on said transparent medium to form a transmitted image beam;
a beam splitter set above said transparent plate to split said transmitted image beam into a first transmitted image partial-beam and a second transmitted image partial-beam;
a first CCD array set above said transparent plate to receive said first transmitted image partial-beam; and
a second CCD array set above said transparent plate to receive said second transmitted image partial-beam.

11. The scanner according to claim 10, further comprising moving apparatus set above said transparent plate to move said first light-source, said beam splitter, said first CCD array and said second CCD array in one scan action.

12. The scanner according to claim 10, further comprising a beam-directing module set above said transparent plate to direct said first transmitted image partial-beam into said first CCD array and direct said second transmitted image partial-beam into said second CCD array.

13. The scanner according to claim 12, wherein said beam-directing module comprises a first mirror set in an optical route of said first transmitted image partial-beam and a second mirror set in an optical route of said second transmitted image partial-beam.

14. The scanner according to claim 10, further comprising a focus-image lens-module set above said transparent plate to respectively focus and image said first transmitted image partial-beam and said second transmitted image partial-beam on said first CCD array and said second CCD array.

15. The scanner according to claim 10, wherein said light-source is a CCFL or its similar visible light-source.

16. The scanner according to claim 10, wherein said light-source is composed of a CCFL or its similar visible light-source and an Infrared Light Emitting Diode (IR-LED), and all of said transmitted image beam, said first transmitted image partial-beam and said second transmitted image partial-beam contain a visible-light portion emitted from said CCFL or its similar visible light-source and an IR-light portion emitted from said IR-LED.

17. The scanner according to claim 16, further comprising:
a visible-light filter set before said first CCD array to filter said IR-light portion of said first transmitted image partial-beam and pass said visible-light portion of said first transmitted image partial-beam; and
an IR-light filter set before said second CCD array to filter said visible-light portion of said second transmitted image partial-beam and pass said IR-light portion of said second transmitted image partial-beam.

18. The scanner according to claim 10, wherein said first CCD array and said second CCD array are selected from the group consisting of a single-line grayscale CCD array and a three-line RGB CCD array.

19. The scanner according to claim 10, wherein said first CCD array and said second CCD array have the same pixel quantity and pixel-distance and have a relative displacement of half pixel-distance in their longitudinal direction.

20. The scanner according to claim 19, comprising a motor or a linear driving module to drive said second CCD array to move said half pixel-distance.

21. The scanner according to claim 10, wherein said transparent plate is a film holder to hold a scanned film at a scan position.

22. The scanner according to claim 10, wherein said first transmitted image partial-beam is formed by said beam splitter reflecting approximate 50% of said transmitted image beam by an angle, and said second transmitted image partial-beam is formed by said beam splitter transmitting approximate 50% of said transmitted image beam.

23. A scanner, comprising:
a first transparent plate to hold a reflective medium;
a second transparent plate parallel to said first transparent plate to hold a transparent medium;
a first light-source set below said second transparent plate, wherein a first incident light emitted from said first light-source impinges on said transparent medium to form a transmitted image beam; and
an optical carriage set between said first transparent plate and said second transparent plate to move along a direction parallel to said first transparent plate, wherein said first light-source moves jointly with said optical carriage, and said optical carriage comprises:
a second light-source, wherein a second incident light emitted from said second light-source reflects on a surface of said reflective medium to form a first reflected image beam;
a third light-source separate from said second light-source by a distance, wherein a third incident light emitted from said third light-source reflects on said surface of said reflective medium to form a second reflected image beam, and said second reflected image beam and said first reflected image beam are formed in one scan action;
a beam splitter to split said transmitted image beam into a first transmitted image partial-beam and a second transmitted image partial-beam;
a first CCD array to receive said first reflected image beam and said first transmitted image partial-beam, wherein the longitudinal direction of said first CCD array is parallel to said first transparent plate and perpendicular to the moving direction of said optical carriage;
a second CCD array to receive said second reflected image beam and said second transmitted image partial-beam, wherein said second CCD array is parallel to said first CCD array;
spacing apparatus set between said second light-source and said third light-source to prevent said first reflected image beam from irradiating on said second CCD array and prevent said second reflected image beam from irradiating on said first CCD array; and
an optical-route switching module to select one of said first reflected image beam and said first transmitted image partial-beam to impinge on said first CCD array, and select one of said second reflected image beam and said second transmitted image partial-beam to impinge on said second CCD array.

24. The scanner according to claim 23, wherein said optical carriage further comprises a beam-directing module to respectively direct said first reflected image beam and said second reflected image beam into said first CCD array and said second CCD array.

25. The scanner according to claim 24, wherein said beam-directing module comprises:
a first mirror set in an optical route of said first reflected image beam; and
a second mirror set in an optical route of said second reflected image beam.

26. The scanner according to claim 25, wherein said optical-route switching module comprises:
a first switching mirror set between said first mirror and said first CCD array; and
a second switching mirror set between said second mirror and said second CCD array.

27. The scanner according to claim 23, wherein said optical carriage further comprises a focus-image lens-module to focus and image said first reflected image beam and said first transmitted image partial-beam on said first CCD array, and focus and image said second reflected image beam and said second transmitted image partial-beam on said second CCD array.

28. The scanner according to claim 23, wherein said second light-source and said third light-source are CCFLs or their similar visible light-sources.

29. The scanner according to claim 23, wherein said first light-source is composed of a CCFL or its similar visible light-source and an IR-LED, and all of said first incident light, said transmitted image beam, said first transmitted image partial-beam and said second transmitted image partial-beam contain a visible-light portion emitted from said CCFL or its similar visible light-source and an IR-light portion emitted from said IR-LED.

30. The scanner according to claim 29, further comprising:
a visible-light filter set before said first CCD array to filter said IR-light portion of said first transmitted image partial-beam and pass said visible-light portion of said first transmitted image partial-beam; and
an IR-light filter set before said second CCD array to filter said visible-light portion of said second transmitted image partial-beam and pass said IR-light portion of said second transmitted image partial-beam.

31. The scanner according to claim 23, wherein said first CCD array and said second CCD array are selected from the group consisting of a single-line grayscale CCD array and a three-line RGB CCD array.

32. The scanner according to claim 23, wherein said first CCD array and said second CCD array have the same pixel quantity and pixel-distance and have a relative displacement of half pixel-distance in their longitudinal direction.

33. The scanner according to claim 32, comprising a motor or a linear driving module to drive said second CCD array to move said half pixel-distance.

34. The scanner according to claim 23, wherein said second transparent plate is a film holder to hold a scanned film at a scan position.

35. The scanner according to claim 23, wherein said first transmitted image partial-beam is formed by said beam splitter reflecting approximate 50% of said transmitted image beam by an angle, and said second transmitted image partial-beam is formed by said beam splitter transmitting approximate 50% of said transmitted image beam.

36. A scanner, comprising:
a transparent plate to hold a reflective medium;
a light-source movably set below said transparent plate, wherein an incident light emitted from said light-source reflects on a surface of said reflective medium to form a reflected image beam;
a focus-image lens set below said transparent plate to receive said reflected image beam and transmit a output image beam;
a beam splitter set below said transparent plate to split said output image beam into a first image partial-beam and a second image partial-beam;
a first CCD array set below said transparent plate, wherein said first image partial-beam is focused and imaged on said first CCD array; and
a second CCD array set below said transparent plate, wherein said second image partial-beam is focused and imaged on said second CCD array.

37. The scanner according to claim 36, further comprising moving apparatus set below said transparent plate to move said light-source, said focus-image lens, said beam splitter, said first CCD array, and said second CCD array.

38. The scanner according to claim 36, further comprising a beam-directing module set below said transparent plate to direct said reflected image beam into said focus-image lens.

39. The scanner according to claim 38, wherein said beam-directing module comprises at least one mirror to alter an optical route of said reflected image beam.

40. The scanner according to claim 36, wherein said light-source is a CCFL or its similar visible light-source.

41. The scanner according to claim 36, wherein said light-source is composed of a CCFL or its similar visible light-source and an IR-LED, and all of said incident light, said reflected image beam, said output image beam, said first image partial-beam and said second image partial-beam contain a visible-light portion emitted from said CCFL or its similar visible light-source and an IR-light portion emitted from said IR-LED.

42. The scanner according to claim 41, further comprising:
a visible-light filter set before said first CCD array to filter said IR-light portion of said first image partial-beam and pass said visible-light portion of said first image partial-beam; and
an IR-light filter set before said second CCD array to filter said visible-light portion of said second image partial-beam and pass said IR-light portion of said second image partial-beam.

43. The scanner according to claim 36, wherein said first CCD array and said second CCD array are selected from the group consisting of a single-line grayscale CCD array and a three-line RGB CCD array.

44. The scanner according to claim 36, wherein said first CCD array and said second CCD array have the same pixel quantity and pixel-distance and have a relative displacement of half pixel-distance in their longitudinal direction.

45. The scanner according to claim 44, comprising a motor or a linear driving module to drive said second CCD array to move said half pixel-distance.

46. The scanner according to claim 36, wherein said first image partial-beam is formed by said beam splitter reflecting approximate 50% of said output image beam by an angle, and said second image partial-beam is formed by said beam splitter transmitting approximate 50% of said output image beam.

47. A scanner, comprising:
a transparent plate to hold a transparent medium;
a light-source movably set below said transparent plate, wherein an incident light emitted from said light-source impinges on said transparent medium to form a transmitted image beam;
a focus-image lens set above said transparent plate to receive said transmitted image beam and transmit a output image beam;
a beam splitter set above said transparent plate to split said output image beam into a first image partial-beam and a second image partial-beam;
a first CCD array set above said transparent plate, wherein said first image partial-beam is focused and imaged on said first CCD array; and
a second CCD array set above said transparent plate, wherein said second image partial-beam is focused and imaged on said second CCD array.

48. The scanner according to claim 47, further comprising a moving apparatus set above said transparent plate to move said light-source, said focus-image lens, said beam splitter, said first CCD array, and said second CCD array.

49. The scanner according to claim 47, further comprising a beam-directing module set above said transparent plate to direct said transmitted image beam into said focus-image lens.

50. The scanner according to claim 49, wherein said beam-directing module comprises at least one mirror to alter an optical route of said transmitted image beam.

51. The scanner according to claim 47, wherein said light-source is a CCFL or its similar visible light-source.

52. The scanner according to claim 47, wherein said light-source is composed of a CCFL or its similar visible light-source and an IR-LED, and all of said incident light, said transmitted image beam, said output image beam, said first image partial-beam and said second image partial-beam contain a visible-light portion emitted from said CCFL or its similar visible light-source and an IR-light portion emitted from said IR-LED.

53. The scanner according to claim 52, further comprising:
a visible-light filter set before said first CCD array to filter said IR-light portion of said first image partial-beam and pass said visible-light portion of said first image partial-beam; and
an IR-light filter set before said second CCD array to filter said visible-light portion of said second image partial-beam and pass said IR-light portion of said second image partial-beam.

54. The scanner according to claim 47, wherein said first CCD array and said second CCD array are selected from the group consisting of a single-line grayscale CCD array and a three-line RGB CCD array.

55. The scanner according to claim 47, wherein said first CCD array and said second CCD array have the same pixel quantity and pixel-distance and have a relative displacement of half pixel-distance in their longitudinal direction.

56. The scanner according to claim 55, comprising a motor or a linear driving module to drive said second CCD array to move said half pixel-distance.

57. The scanner according to claim 47, wherein said first image partial-beam is formed by said beam splitter reflecting approximate 50% of said output image beam by an angle, and said second image partial-beam is formed by said beam splitter transmitting approximate 50% of said output image beam.

58. The scanner according to claim 47, wherein said transparent plate is a film holder to hold a scanned film at a scan position.

59. A scanner, comprising:
a first transparent plate to hold a reflective medium;
a second transparent plate parallel to said first transparent plate to hold a transparent medium;
a first light-source set below said second transparent plate, wherein a first incident light emitted from said first light-source impinges on said transparent medium to form a transmitted image beam; and
an optical carriage set between said first transparent plate and said second transparent plate to move along a direction parallel to said first transparent plate, wherein said first light-source moves jointly with said optical carriage, and said optical carriage comprises:
a second light-source, wherein a second incident light emitted from said second light-source reflects on a surface of said reflective medium to form a reflected image beam;
a focus-image lens to receive said transmitted image beam and said reflected image beam and transmit a output image beam;
a beam splitter to split said output image beam into a first image partial-beam and a second image partial-beam;
a first CCD array, wherein the longitudinal direction of said first CCD array is parallel to said first transparent plate and perpendicular to the moving direction of said optical carriage, and said first image partial-beam is focused and imaged on said first CCD array;
a second CCD array, wherein said second CCD array is parallel to said first CCD array, and said second image partial-beam is focused and imaged on said second CCD array; and
an optical-route switching module to select one of said transmitted image beam and said reflected image beam to impinge on said focus-image lens.

60. The scanner according to claim 59, wherein said optical carriage further comprises a beam-directing module to direct said reflected image beam into said focus-image lens.

61. The scanner according to claim 60, wherein said beam-directing module comprises at least one mirror set in an optical route of said reflected image beam.

62. The scanner according to claim 61, wherein said optical-route switching module comprises at least one switching mirror set between said mirror and said focus-image lens.

63. The scanner according to claim 59, wherein said first light-source is a CCFL or its similar visible light-source.

64. The scanner according to claim 59, wherein said first light-source is composed of a CCFL or its similar visible light-source and an IR-LED, and all of said first incident light, said transmitted image beam, said output image beam, said first image partial-beam and said second image partial-beam contain a visible-light portion emitted from said CCFL or its similar visible light-source and an IR-light portion emitted from said IR-LED.

65. The scanner according to claim 64, further comprising:
a visible-light filter set before said first CCD array to filter said IR-light portion of said first image partial-beam and pass said visible-light portion of said first image partial-beam; and
an IR-light filter set before said second CCD array to filter said visible-light portion of said second image partial-beam and pass said IR-light portion of said second image partial-beam.

66. The scanner according to claim 59, wherein said second light-source is a CCFL or its similar visible light-source.

67. The scanner according to claim 59, wherein said second light-source is composed of a CCFL or its similar visible light-source and an IR-LED, and all of said second incident light, said reflected image beam, said output image beam, said first image partial-beam and said second image partial-beam contain a visible-light portion emitted from said CCFL or its similar visible light-source and an IR-light portion emitted from said IR-LED.

68. The scanner according to claim 67, further comprising:
a visible-light filter set before said first CCD array to filter said IR-light portion of said first image partial-beam and pass said visible-light portion of said first image partial-beam; and
an IR-light filter set before said second CCD array to filter said visible-light portion of said second image partial-beam and pass said IR-light portion of said second image partial-beam.

69. The scanner according to claim 59, wherein said first CCD array and said second CCD array are selected from the group consisting of a single-line grayscale CCD array and a three-line RGB CCD array.

70. The scanner according to claim 59, wherein said first CCD array and said second CCD array have the same pixel quantity and pixel-distance and have a relative displacement of half pixel-distance in their longitudinal direction.

71. The scanner according to claim 59, comprising a motor or a linear driving module to drive said second CCD array to move said half pixel-distance.

72. The scanner according to claim 59, wherein said first image partial-beam is formed by said beam splitter reflecting approximate 50% of said output image beam by an angle, and said second image partial-beam is formed by said beam splitter transmitting approximate 50% of said output image beam.

73. The scanner according to claim 59, wherein said second transparent plate is a film holder to hold a scanned film at a scan position.

74. An image recovery method for the scanned image of a reflective medium applied in the scanner according to claim 1, comprising:
setting said first incident light and said second incident light to impinge on said reflective medium at different incident angles in the same scan action;
respectively capturing said first reflected image beam and said second reflected image beam to form a first electronic image data and a second electronic image data;
comparing said first electronic image data and said second electronic image data to find the image defects caused by the hetero-points of said reflective medium; and
recovering said image defects.

75. An image recovery method for the scanned image of a transparent medium, comprising:
impinging an incident light on said transparent medium to form a transmitted image beam behind said transparent medium;
splitting said transmitted image beam into a first transmitted image partial-beam and a second transmitted image partial-beam;
filtering the IR-light portion of said first transmitted image partial-beam to form a visible-light image-beam;
filtering the visible-light portion of said second transmitted image partial-beam to form an IR-light image-beam;
capturing said visible-light image-beam to form a first electronic image data;
capturing said IR-light image-beam to form a second electronic image data;
comparing said first electronic image data and said second electronic image data to find the image defects caused by the hetero-points of said transparent medium; and
recovering said image defects.

76. An image recovery method for a scanned image of a reflective medium, comprising:
impinging an incident light on a surface of said reflective medium to form a reflected image beam;
splitting said reflected image beam into a first image partial-beam and a second image partial-beam;
filtering the IR-light portion of said first image partial-beam to form a visible-light image-beam;
filtering the visible-light portion of said second image partial-beam to form an IR-light image-beam;
capturing said visible-light image-beam to form a first electronic image data;
capturing said IR-light image-beam to form a second electronic image data;
comparing said first electronic image data and said second electronic image data to find the image defects caused by the hetero-points of said reflective medium; and
recovering said image defects.

77. A scan and process method of an object image, comprising:
capturing a first image beam and a second image beam in one scan action to respectively form a first electronic image data and a second electronic image data, wherein said first image beam and said second image beam correspond to the same pixels of an object with a relative displacement; and
storing said electronic image data and said second electronic image data in a memory in a stagger type to form a third electronic image data, wherein the quantity of pixels of said third electronic image data is equal to an sum of a quantity of pixels of said first electronic image data and said second electronic image data.

78. The method according to claim 77, wherein said relative displacement is equal to half pixel-distance.

79. A scan and process method of an object image, comprising:
capturing a first image beam using a first exposure time and capturing a second image beam using a second exposure time in one scan action to respectively form a first electronic image data and a second electronic image data, wherein said first exposure time and said second exposure time are different; and
synthesizing said first electronic image data and said second electronic image data to form a third electronic image data, wherein said third electronic image data contains some portion of said first electronic image data and some portion of said second electronic image data.

80. The method according to claim 79, wherein said second exposure time is longer than said first exposure time, and the highlights and the shadows of said third electronic image data respectively adopt said first electronic image data and said second electronic image data.
